(19) United States
(12) Patent Application Publication
(10) Pub. No.: US 2019/0135013 A1
(43) Pub. Date: May 9, 2019

(54) LITHOGRAPHIC IMAGING AND PRINTING WITH NEGATIVE-WORKING PHOTORESPONSIVE PRINTING MEMBERS INCLUDING IODONIUM BORATE POLYMERIZATION INITIATORS

(71) Applicants: Maria T. SYPEK, Belchertown, MA (US); Anthony P. KITSON, West Suffield, CT (US); Kevin RAY, Windham, NH (US)

(72) Inventors: Maria T. SYPEK, Belchertown, MA (US); Anthony P. KITSON, West Suffield, CT (US); Kevin RAY, Windham, NH (US)

(21) Appl. No.: 15/804,322

(22) Filed: Nov. 6, 2017

(51) Int. Cl. B41N 1/14; B41M 1/06; B41M 7/00

(52) U.S. Cl. CPC B41N 1/14; B41M 7/0081; B41M 1/06

(57) ABSTRACT

Negative-working, radiation-sensitive printing plates include or consist of a hydrophilic first layer or substrate and, thereover, an oleophilic imaging layer that includes an iodonium borate free-radical initiators in accordance herewith have the structure

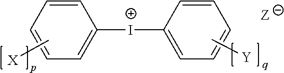

where X and Y are alkoxy, p and q range independently from 0 to 5, and p+q≤5; or p and q may range independently from 0 to 4, with p+q≤4.

### BACKGROUND OF THE INVENTION

In offset lithography, a printable image is present on a printing member as a pattern of ink-accepting (oleophilic) and ink-rejecting (oleophobic) surface areas. Once applied to these areas, ink can be efficiently transferred to a recording medium in the imagewise pattern with substantial fidelity. In a wet lithographic system, the non-image areas are hydrophilic, and the necessary ink-repellency is provided by an initial application of a dampening fluid to the plate prior to inking. The dampening fluid prevents ink from adhering to the non-image areas, but does not affect the oleophilic character of the image areas. Ink applied uniformly to the wetted printing member is transferred to the recording medium only in the imagewise pattern. Typically, the printing member first makes contact with a compliant intermediate surface called a blanket cylinder which, in turn, applies the image to the paper or other recording medium. In typical sheet-fed press systems, the recording medium is pinned to an impression cylinder, which brings it into contact with the blanket cylinder.

To circumvent the cumbersome photographic development, plate-mounting, and plate-registration operations that typify traditional printing technologies, practitioners have developed electronic alternatives that store the imagewise pattern in digital form and impress the pattern directly onto the plate. Plate-imaging devices amenable to computer control include various forms of lasers.

For negative-working plates, exposed regions of the oleophilic, photo-responsive, imaging layer are hardened, or cured (i.e., they resist subsequent development), and unexposed regions of the imaging layer are washed away during development. If an optional topcoat layer is employed, this is washed away during development, in its entirety. The negative-working plate can be developed “off-press” using typical aqueous developing fluids, or alternatively, the plate is manufactured for development on-press (DOP). When off-press development methods are chosen, plates can be processed with the developer fluid, then water-rinsed and finally treated with a conventional gumming solution (which usually contains gum Arabic). Oftentimes, the developer fluid contains gum Arabic, and “one-step, off-press” development becomes possible: the fluid acts as both the traditional developer and gum in one procedure.

For example, an oleophilic, photoresponsive layer may be sensitized in a desired wavelength range by selection of an appropriate photopolymerization initiator. In a negative-working plate, the photoresponsive layer, where exposed, is hardened; unexposed regions are washed off during development. One class of photoinitiator is based on iodonium salts. These compounds are capable of generating radicals sufficient to initiate polymerization in response to radiation in the ultraviolet (UV), visible and/or infrared spectral regions, corresponding to the broad spectral range of from about 150 to about 1500 nm. UV and visible light sensitivity is generally from about 150 to about 700 nm, and infrared sensitivity is typically in the range of about 700 to about 1200 nm.

Iodonium borate compounds are efficient polymerization initiators, providing advantageous imaging speed without vulnerability to unwanted initiation in hot and humid plate storage conditions. Unfortunately, the use of iodonium borates may cause crystallization (“blooming”) on the printing-plate imaging surface, particularly if the formulation includes other mobile ingredients, such as monomer. This ruins the plate, rendering it commercially unusable. Although solutions to the blooming problem have been proposed (see, e.g., U.S. Pat. No. 7,524,614), these have tended to involve long-chain substituents that can be expensive and difficult to manufacture.

### SUMMARY OF THE INVENTION

It has been found, surprisingly, that blooming can be eliminated with short-chain (five or fewer carbon atoms) alkoxy substituents. In particular, iodonium borate free-radical initiators in accordance herewith have the structure

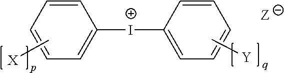

where X and Y are alkoxy, p and q range independently from 0 to 5, and p+q≤5. In some preferred embodiments, p and q range independently from 0 to 4, and p+q≤4. Z^{β} is an organic anion represented by the structure

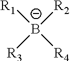

where R₁, R₂, R₃, and R₄ are independently alkyl, aryl, alkenyl, alkynyl, cycloalkyl, or heterocyclyl groups, or two or more of R₁, R₂, R₃, and R₄ can be joined together to form a heterocyclic ring with the boron atom. These structures improve iodonium borate solubility in solvents such as methyl ethyl ketone and otherwise stabilize the radiation-sensitive composition so that blooming does not occur.

Various embodiments of the present invention relate to negative-working imageable printing plates having a photopolymerizable layer including one or more iodonium borate initiators conforming to the above description. The photopolymerizable composition may contain, at minimum, the iodonium borate, a free radically polymerizable component, a radiation-absorbing compound and a polymeric binder. The printing plate can be manufactured for development on-press or can be developed using a developing fluid (e.g., in a platemaker) before mounting on-press. In the latter case, the traditional developer route followed application of finisher, or may be an all-in-one washout developer composition.

Accordingly, in a first aspect, the invention relates to a lithographic printing member, comprising, in various embodiments, a hydrophilic first layer and, thereover, an oleophilic imaging layer comprising (i) a component polymerizable by a free-radical polymerization mechanism, (ii) an initiator for generating, upon exposure to imaging radiation, free radicals to initiate polymerization of the polymerizable component, (iii) a radiation absorber, and (iv) a polymeric binder. The initiator is an iodonium borate compound having the structure shown above, where, again, X and Y are alkoxy, p and q range independently from 0 to 5, p+q≤5, and Z^{⊕} is an organic anion. In some embodiments, p and q range independently from 0 to 4, and p+q≤4.

In some embodiments, the iodonium borate compound is phenyl-(4-butoxyphenyl)-iodonium tetraphenylborate, and in other embodiments, the iodonium borate compound is bis(4-methoxyphenyl)iodonium tetraphenylborate. Z^{⊕} may have the structure shown and described above. In various embodiments, the printing member includes a topcoat—e.g., a polyvinylalcohol—over the imaging layer. The polymeric binder may, for example, be a polyurethane.

In another aspect, the invention pertains to a method of preparing and printing with a lithographic printing member. In various embodiments, the method comprises, first, providing a lithographic printing member comprising (a) a hydrophilic first layer and, (b) thereover, an oleophilic imaging layer comprising (i) a component polymerizable by a free-radical polymerization mechanism, (ii) an initiator for generating, upon exposure to imaging radiation, free radicals to initiate polymerization of the polymerizable component, (iii) a radiation absorber, and (iv) a polymeric binder, where the initiator is an iodonium borate compound having the structure shown and described above, and Z^{⊕} is an organic anion. As a consequence, the printing member does not exhibit blooming. The method further comprises exposing the printing member to imaging radiation in an imagewise pattern to cause polymerization of the polymerizable component, developing the printing member to remove only unexposed portions of the imaging layer, mounting the printing member on a printing press, and printing with the printing member to transfer ink in the imagewise pattern onto recording media.

The developing step may occur prior to or following the mounting step. In some embodiments, p and q range independently from 0 to 4, and p+q≤4. The iodonium borate compound may, in some embodiments, be phenyl-(4-butoxyphenyl)-iodonium tetraphenylborate, while in other embodiments, the iodonium borate compound may be bis(4-methoxyphenyl)iodonium tetraphenylborate. Z^{⊕} may have the structure shown and described above. In various embodiments, the printing member includes a topcoat—e.g., a polyvinylalcohol—over the imaging layer. The polymeric binder may, for example, be a polyurethane.

As used herein, the term “free radical” refers to a highly reactive atom or molecule with at least one unpaired electron. A “free-radical polymerization mechanism” means initiation of polymerization by free radicals that attack short-chain oligomers with ethylenic unsaturation; these free radical species are known as “free-radical initiators.”

The term “oligomer” herein connotes a small polymeric molecule containing only a few (typically fewer than 20, and often fewer than six) monomer units. References to an “oligomer” or a “monomer” generally refer to quantities of the oligomer or monomer species (rather than to single molecules thereof). The term “binder” (or resin) refers to the film-forming element of a coating. It provides adhesion to an underlying substrate, binds pigments, and determines coating properties such as durability and flexibility.

By “aliphatic” is meant organic compounds whose carbon atoms are linked in open chains, either straight or branched, or in a cyclic ring that may itself have side chains. By “alkoxy” is meant an alkyl (carbon and hydrogen chain) group single-bonded to oxygen, i.e., R—O.

The term “plate” or “member” refers to any type of printing member or surface capable of recording an image defined by regions exhibiting differential affinities for ink and/or fountain solution. Suitable configurations include the traditional planar or curved lithographic plates that are mounted on the plate cylinder of a printing press, but can also include seamless cylinders (e.g., the roll surface of a plate cylinder), an endless belt, or other arrangement.

The term “hydrophilic” is used in the printing sense to connote a surface affinity for a fluid which prevents ink from adhering thereto. Such fluids include water for conventional ink systems, aqueous and non-aqueous dampening liquids, and the non-ink phase of single-fluid ink systems. Thus, a hydrophilic surface in accordance herewith exhibits preferential affinity for any of these materials relative to oil-based materials.

The term “substantially” or “approximately” means±10% (e.g., by weight or by volume), and in some embodiments, ±5%. The term “consists essentially of” means excluding other materials that contribute to function or structure. For example, a radiation-sensitive composition consisting essentially of a polymerizable component, an initiator composition, a radiation-absorbing component and a polymeric binder may include other ingredients, such as a catalyst, that may perform important functions but do not constitute part of the polymer structure of the composition following polymerization. Percentages refer to weight percentages unless otherwise indicated.

### DESCRIPTION OF DRAWINGS

The foregoing discussion will be understood more readily from the following detailed description of the disclosed technology, when taken in conjunction with the single FIGURE of the drawing, which is an enlarged cross-sectional view of a negative-working printing member according to the invention.

### DETAILED DESCRIPTION

### 1. Imaging Apparatus

The coated plate is imaged in an imaging device, typically by means of a modulated signal, e.g., a modulated near-IR laser. The laser is rastered over the plate surface while the laser intensity is modulated according to digital information so that only the background areas of the plate receive exposure. An imaging apparatus suitable for use in conjunction with the present printing members includes at least one laser device that emits in the region of maximum plate responsiveness, i.e., whose λₘₐₓ closely approximates the wavelength region where the plate absorbs most strongly. Specifications for lasers that emit in the near-IR region are fully described in U.S. Pat. No. Re. 35,512 (“the '512 patent”) and U.S. Pat. No. 5,385,092 (“the '092 patent”), the entire disclosures of which are hereby incorporated by reference. Lasers emitting in other regions of the electromagnetic spectrum are well-known to those skilled in the art.

Suitable imaging configurations are also set forth in detail in the '512 and '092 patents. Briefly, laser output can be provided directly to the plate surface via lenses or other beam-guiding components, or transmitted to the surface of a blank printing plate from a remotely sited laser using a fiber-optic cable. A controller and associated positioning hardware maintain the beam output at a precise orientation with respect to the plate surface, scan the output over the surface, and activate the laser at positions adjacent selected points or areas of the plate. The controller responds to incoming image signals corresponding to the original document or picture being copied onto the plate to produce a precise negative or positive image of that original. The image signals are stored as a bitmap data file on a computer. Such files may be generated by a raster image processor (“RIP”) or other suitable means. For example, a RIP can accept input data in page-description language, which defines all of the features required to be transferred onto the printing plate, or as a combination of page-description language and one or more image data files. The bitmaps are constructed to define the hue of the color as well as screen frequencies and angles.

The level of the exposure depends on the power of the laser, the size of the laser spot, and the composition of the coating, but is preferably chosen to deliver an area energy density or fluence between 100 and 250 mJ/cm², and more preferably between 125 and 200 mJ/cm². Examples of suitable exposure devices are the COMPASS 8030 and the DIMENSION PRO 800, both provided by Presstek Inc. Other imaging systems, such as those involving light valving and similar arrangements, can also be employed; see, e.g., U.S. Pat. Nos. 4,577,932; 5,517,359; 5,802,034; and 5,861,992, the entire disclosures of which are hereby incorporated by reference. Moreover, it should also be noted that image spots may be applied in an adjacent or in an overlapping fashion. The imaging device is typically integrated into a platemaker (e.g., the DIMENSION PRO 800) or a printing press, e.g., a Heidelberg GTO press.

### 2. Lithographic Printing Members

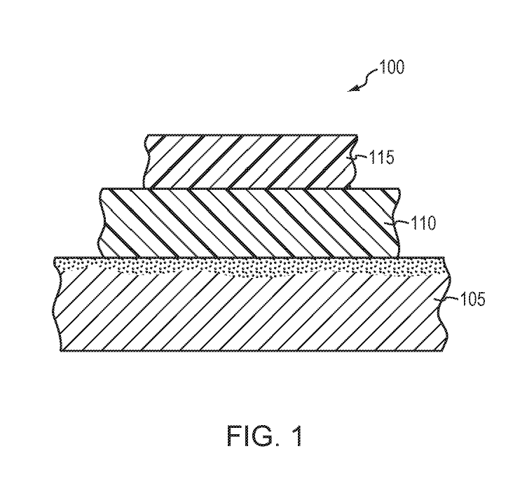

FIG. 1 illustrates a negative-working printing member 100 according to the invention that includes a hydrophilic substrate 105, an oleophilic photoresponsive layer 110, and a topcoat layer 115. Layer 110 is sensitive to imaging (generally infrared or “IR”) radiation as discussed below, and imaging of the printing member 100 (by exposure to IR radiation) renders the layer insoluble when subjected to fountain solution. The optional topcoat layer 115 is always removed during development in its entirety, regardless of exposure. Most or all of the layers used in the present invention are continuous. The term “continuous” as used herein means that the underlying surface is completely covered with a uniform layer of the deposited material. Each of the layers and its functions are described in detail below.

Following imagewise exposure using, e.g., IR radiation to produce exposed and unexposed regions, the plate may or may not be baked. The plate is then developed to remove only the unexposed regions. Development may be carried out on-press using fountain solution (during print “make ready”), lithographic printing ink, or a combination.

### 2.1 Substrate 105

The substrate provides dimensionally stable mechanical support to the printing member. The substrate should be strong, stable, and flexible. One or more surfaces (and, in some cases, bulk components) of the substrate is hydrophilic, and the substrate itself is desirably metal. In general, metal layers undergo special treatment in order to be capable of accepting fountain solution in a printing environment. Any number of chemical or electrical techniques, in some cases assisted by the use of fine abrasives to roughen the surface, may be employed for this purpose. For example, electrograining involves immersion of two opposed aluminum plates (or one plate and a suitable counterelectrode) in an electrolytic cell and passing alternating current between them. The result of this process is a finely pitted surface topography that readily adsorbs water. See, e.g., U.S. Pat. No. 4,087,341.

A structured or grained surface can also be produced by controlled oxidation, a process commonly called “anodizing.” An anodized aluminum substrate consists of an unmodified base layer and a porous, “anodic” aluminum oxide coating thereover; this coating readily accepts water. Without further treatment, however, the oxide coating would lose wettability due to further chemical reaction. Anodized plates are, therefore, typically exposed to a silicate solution or other suitable (e.g., phosphate) reagent that stabilizes the hydrophilic character of the plate surface. In the case of silicate treatment, the surface may assume the properties of a molecular sieve with a high affinity for molecules of a definite size and shape-including, most importantly, water molecules. The treated surface also promotes adhesion to an overlying photopolymer layer. Anodizing and silicate treatment processes are described in U.S. Pat. Nos. 3,181,461 and 3,902,976. The anodizing thickness is preferably 0.4 to 3 μm thick (as measured by scanning electron microscopy), more preferably 0.7 to 1.5 μm thick, and ideally about 1 μm thick.

Preferred hydrophilic substrate materials include aluminum that has been mechanically, chemically, and/or electrically grained with subsequent anodization. The surface of substrate 105 has characteristics matched to performance of the overlying layer. The thickness of substrate 105 generally ranges from 0.004 to 0.02 inch, with thicknesses in the range 0.005 to 0.012 inch being particularly preferred.

In other embodiments, the hydrophilic surface is provided by a layer that does not itself serve as a substrate—e.g., which is laminated or coated onto a heavier substrate layer.

### 2.2 Photoresponsive Layer 110

Layer 110 is typically applied as a coating and includes a component polymerizable by a free-radical mechanism, a free-radical initiator, a radiation-absorbing compound, and a polymeric binder. The free-radical initiator is an iodonium borate compound as described below. The radiation absorber may be a dye, and the composition may also contain one or more additives such as, for example, a coating surfactant.

The iodonium borate may be added to the imageable composition as the iodonium cation accompanied by a non-borate anion (PF⁶⁻, for example), and as the borate anion accompanied by a non-iodonium cation (Na⁺, for example). In preferred embodiments, the iodonium cation is added to an imageable composition with the borate anion in intimate association.

### 2.2.1 Iodonium Borate Initiator

Iodonium borate free-radical initiators in accordance herewith have the structure

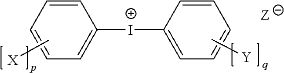

where X and Y are alkoxy, p and q range independently from 0 to 5, and p+q≤5. In some preferred embodiments, p and q range independently from 0 to 4, and p+q≤4. Z^{⊕} is an organic anion represented by the structure

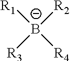

where R₁, R₂, R₃, and R₄ are independently alkyl, aryl, alkenyl, alkynyl, cycloalkyl, or heterocyclyl groups, or two or more of R₁, R₂, R₃, and R₄ can be joined together to form a heterocyclic ring with the boron atom. Useful boron components are described, for example, in U.S. Pat. No. 6,569,603, the entire disclosure of which is hereby incorporated by reference. For example, R₁, R₂, R₃, and R₄ may be independently substituted or unsubstituted alkyl groups having 1 to 12 carbon atoms (such as methyl, ethyl, n-propyl, iso-propyl, n-butyl, isobutyl, t-butyl, all pentyl isomers, 2-methylpentyl, all hexyl isomers, 2-ethylhexyl, all octyl isomers, 2,4,4-trimethylpentyl, all nonyl isomers, all decyl isomers, all undecyl isomers, all dodecyl isomers, methoxymethyl, and benzyl) other than fluoroalkyl groups, substituted or unsubstituted carbocyclic aryl groups having 6 to 10 carbon atoms in the aromatic ring (such as phenyl, p-methylphenyl, 2,4-methoxyphenyl, naphthyl, and pentafluorophenyl groups), substituted or unsubstituted alkenyl groups having 2 to 12 carbon atoms (such as ethenyl, 2-methylethenyl, allyl, vinylbenzyl, acryloyl, and crotonotyl groups), substituted or unsubstituted alkynyl groups having 2 to 12 carbon atoms (such as ethynyl, 2-methylethynyl, and 2,3-propynyl groups), substituted or unsubstituted cycloalkyl groups having 3 to 8 carbon atoms in the ring structure (such as cyclopropyl, cyclopentyl, cyclohexyl, 4-methylcyclohexyl, and cyclooctyl groups), or substituted or unsubstituted heterocyclyl groups having 5 to 10 carbon, oxygen, sulfur, and nitrogen atoms (including both aromatic and non-aromatic groups, such as substituted or unsubstituted pyridyl, pyrimidyl, furanyl, pyrrolyl, imidazolyl, triazolyl, tetrazoylyl, indolyl, quinolinyl, oxadiazolyl, and benzoxazolyl groups). Alternatively, two or more of R₁, R₂, R₃, and R₄ can be joined together to form a heterocyclic ring with the boron atom, such rings having up to 7 carbon, nitrogen, oxygen, or nitrogen atoms.

The initiator is capable of generating radicals sufficient to initiate polymerization of the polymerizable component upon exposure to the imaging radiation. A preferred iodonium borate compound is phenyl-(4-butoxyphenyl)-iodonium tetraphenylborate:

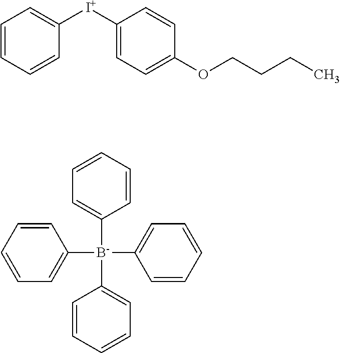 [SMILES: CCCCOc1ccc([I+]c2ccccc2)cc1 ; c1ccc([B-](c2ccccc2)(c2ccccc2)c2ccccc2)cc1]

and bis(4-methoxyphenyl)iodonium tetraphenylborate:

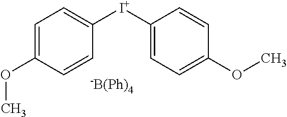 [SMILES: COc1ccc([I+]c2ccc(OC)cc2)cc1 ; "-B(Ph)4"]

Co-initiators can also be used. Suitable co-initiators include metallocenes (such as titanocenes and ferrocenes), mono- and polycarboxylic acids such as anilino diacetic acid, haloalkyl triazines, thiols or mercaptans (such as mercaptotriazoles), borate salts, and photooxidants containing a heterocyclic nitrogen that is substituted by an alkoxy or acyloxy group, as described in U.S. Pat. No. 5,942,372.

The initiator composition including one or more initiator compounds is generally present in the photoresponsive composition in an amount of from about 0.5% to about 30%, based on the total solids of the photoresponsive composition or the dry weight of the coated layer. The initiator composition may, for example, be present in an amount of from about 1% to about 20 wt %. In various embodiments, one or more diaryliodonium borate compounds generally comprise from about 2 to about 5% of the initiator composition.

### 2.2.2 Polymerizable Component/Monomer

The polymerizable component comprises, consists essentially of or consists of one or more compounds that have one or more ethylenically unsaturated polymerizable or crosslinkable groups that can be polymerized or crosslinked using free-radical initiation. For example, the polymerizable component can be ethylenically unsaturated monomers, oligomers, and crosslinkable polymers, or various combinations of such compounds. Thus, suitable ethylenically unsaturated compounds that can be polymerized or crosslinked include ethylenically unsaturated polymerizable monomers that have one or more of the polymerizable groups, including unsaturated esters of alcohols, such as (meth)acrylate esters of polyols. Oligomers and/or prepolymers, such as urethane (meth)acrylates, epoxide(meth)acrylates, polyester(meth)acrylates, polyether(meth)acrylates, free-radical crosslinkable polymers, and unsaturated polyester resins can also be used. In some embodiments, the polymerizable component may comprise carboxy groups.

Useful polymerizable components include free-radical polymerizable monomers or oligomers that comprise addition polymerizable ethylenically unsaturated groups including multiple acrylate and methacrylate groups and combinations thereof, or free-radical crosslinkable polymers, or combinations of these classes of materials. More particularly useful polymerizable compounds include those derived from urea urethane(meth)acrylates or urethane(meth)acrylates having multiple polymerizable groups. For example, a suitable polymerizable component can be prepared by reacting DESMODUR N100 aliphatic polyisocyanate resin based on hexamethylene diisocyanate (Bayer Corp., Milford, Conn.) with hydroxyethyl acrylate and pentaerythritol triacrylate. Other preferred polymerizable compounds are available from Sartomer Company, Inc. such as SR399 (dipentaerythritol pentaacrylate), SR355 (di-trimethylolpropane tetraacrylate), SR295 (pentaerythritol tetraacrylate), and others that would be readily apparent to one skilled in the art. Also useful are urea urethane(meth)acrylates and urethane(meth)acrylates described in U.S. Pat. Nos. 6,582,882 and 6,899,994, both of which are incorporated by reference. In the present invention, at least a portion (and in some embodiments all) of the polymerizable component consists of, or consists essentially of, a non-particulate, aliphatic urethane acrylic oligomer that is infinitely water-dilutable but not water soluble.

Numerous other polymerizable compounds are known to those skilled in the art and are described in the considerable literature including Photoreactive Polymers: The Science and Technology of Resists, A Reiser, Wiley, N.Y., 1989, pp. 102-177; B. M. Monroe in Radiation Curing: Science and Technology, S. P. Pappas, Ed., Plenum, N.Y., 1992, pp. 399-440: and “Polymer Imaging” by A. B. Cohen and P. Walker, in Imaging Processes and Material, J. M. Sturge et al. (Eds.), Van Nostrand Reinhold, N.Y., 1989, pp. 226-262. For example, useful polymerizable components are also described in EP 1,182,033 beginning with paragraph [0170].

The polymerizable component is present in the photoresponsive composition in an amount sufficient to render the composition insoluble in an aqueous medium after exposure to radiation. This is generally from about 20 to about 75 wt % and preferably from about 40 to about 75 wt % based on the dry weight of the photoresponsive composition. For example, the weight ratio of polymerizable component to the polymeric binder may be from about 5:1 to about 1:1.

### 2.2.3 Polymeric Binder

Polymeric binders can be any of those known in the art for use in negative-working photoresponsive compositions. These polymeric binders generally have a molecular weight of from about 2,000 to about 1,000,000 and preferably from about 10,000 to about 200,000. The acid value (mg KOH/g) of the polymeric binder is generally from about 20 to about 400 as determined using known methods. Such polymeric binders can be particulate or film-forming in nature. Furthermore, in some embodiments, the polymeric binder takes part in the polymerization reaction; for example, the polymer binder may contain ethylenic unsaturation.

Examples of polymeric binders include, but are not limited to, those derived at least in part from one or more monomers having pendant carboxyl groups such as (meth)acrylic acids, (meth)acrylates, (meth)acrylamides, (meth)acrylonitriles, poly(alkylene glycols), poly(alkylene glycol)(meth)acrylates, vinyl acetals, styrene and substituted styrenes, N-substituted cyclic imides or maleic anhydrides, such as those described in EP 1,182,033 and U.S. Pat. Nos. 6,309,792, 6,352,812, 6,569,603, and 6,893,797. Phenolic resins may also be used. Also useful are the vinyl carbazole polymers having pendant N-carbazole moieties including those described in U.S. Pat. No. 4,774,163 and polymers having pendant vinyl groups including those described in U.S. Pat. Nos. 6,899,994 and 4,511,645, and EP 1,182,033. In some embodiments, polymers derived from one or more monomers with pendant carboxy groups, (meth)acrylates, styrene and styrene derivatives, vinyl acetal, N-substituted cyclic imides, maleic anhydride, vinyl carbazoles, monomers with multiple vinyl groups, (meth)acrylonitriles, (meth)acrylamides, poly(alkylene glycols), poly(alkylene glycol) (meth)acrylates, and N-substituted (meth)acrylamides are employed as polymeric binders.

Other useful polymeric binders are dispersible or soluble in water or water/solvent mixtures such as fountain solutions. Such polymeric binders include polymeric emulsions, dispersions, or graft polymers having pendant poly(alkyleneoxide) side chains that can augment the plate's amenability to on-press development by subjection to fountain solution. Such polymeric binders are described, for example, in U.S. Pat. Nos. 6,582,882 and 6,899,994. Other useful polymeric binders have hydrophobic backbones and comprise both of the following a) and b) recurring units, or the b) recurring units alone:
a) recurring units having pendant cyano groups attached directly to the hydrophobic backbone, and
b) recurring units having pendant groups comprising poly(alkylene oxide) segments.

These polymeric binders may comprise poly(alkylene oxide) segments and preferably poly(ethylene oxide) segments. They can, for example, be graft copolymers having a main chain polymer and poly(alkylene oxide) pendant side chains or segments or block copolymers having blocks of (alkylene oxide)-containing recurring units and non(alkylene oxide)-containing recurring units. Both graft and block copolymers can additionally have pendant cyano groups attached directly to the hydrophobic backbone. The alkylene oxide constitutional units are generally C₁ to C₆ alkylene oxide groups, and more typically C₁ to C₃ alkylene oxide groups. The alkylene portions can be linear or branched or substituted versions thereof.

In some embodiments, the polymeric binders contain only recurring units comprising poly(alkylene oxide) segments, but in other embodiments, the polymeric binders comprise recurring units comprising the poly(alkylene oxide) segments as well as recurring units having pendant cyano groups attached directly to the hydrophobic backbone. By way of example only, such recurring units can comprise pendant groups comprising cyano, cyano-substituted alkylene groups, or cyano-terminated alkylene groups. Recurring units can also be derived from ethylenically unsaturated polymerizable monomers such as acrylonitrile, methacrylonitrile, methyl cyanoacrylate, ethyl cyanoacrylate, or a combination thereof. However, cyano groups can be introduced into the polymer by other conventional means. Examples of such cyano-containing polymeric binders are described, for example, in U.S. Patent Publ. No. 2005/003285. By way of example, suitable polymeric binders can be formed by polymerization of a combination or mixture of suitable ethylenically unsaturated polymerizable monomers or macromers, such as:
A) acrylonitrile, methacrylonitrile, or a combination thereof,
B) poly(alkylene oxide) esters of acrylic acid or methacrylic acid, such as poly(ethylene glycol) methyl ether acrylate, poly(ethylene glycol) methyl ether methacrylate, or a combination thereof, and
C) optionally, monomers such as acrylic acid, methacrylic acid, styrene, hydroxystyrene, acrylate esters, methacrylate esters, acrylamide, methacrylamide, or a combination of such monomers.

The amount of the poly(alkylene oxide) segments in these polymeric binders may be from about 0.5 to about 60 wt %, e.g., from about 2 to about 50 wt %, from about 5 to about 40 wt %, or from about 5 to about 20 wt %. The amount of (alkylene oxide) segments in the block copolymers is generally from about 5 to about 60 wt %, e.g., from about 10 to about 50 wt %, or from about 10 to about 30 wt %. It is also possible that the polymeric binders having poly(alkylene oxide) side chains are present in the form of discrete particles.

Still other polymeric binders are represented by the following structure:

-(A)ₓ-(B)_{y}-(C)_{z}-

where A represents recurring units comprising a pendant —C(═O)O—CH₂CH═CH₂ group, B represents recurring units comprising pendant cyano groups, and C represents recurring units other than those represented by A and B and optionally including recurring units having pendant carboxy groups (for example, recurring units in which the carboxy groups are not converted to —C(═O)O—CH₂CH═CH₂ groups). B may represent recurring units derived from (meth)acrylonitrile, and C represents recurring units derived from one or more (meth)acrylic acid esters, (meth)acrylamides, vinyl carbazole, styrene and styrenic derivatives thereof, N-substituted maleimides, (meth)acrylic acid, maleic anhydride, vinyl acetate, vinyl ketones (such as vinyl methyl ketone), vinyl pyridines, N-vinyl pyrrolidones, 1-vinylimidazole, and vinyl polyalkylsilanes (such as vinyl trimethylsilane). For example, B may represent recurring units derived from acrylonitrile, with C derived from one or more of methacrylic acid, acrylic acid, vinyl carbazole, methyl methacrylate, 2-hydroxyethyl methacrylate, styrene, and N-phenylmaleimide.

The polymeric binders represented by the above structure are generally present in the photoresponsive composition (and imageable layer) in an amount of from about 10 to about 70 wt %, based on the total composition or layer solids. In some embodiments, the amount is from about 20 to about 50 wt %. The polymeric binders described above can be present in an amount of from about 1.5 to about 75%, e.g., from about 1.5 to about 40%, based on the total solids content of the photoresponsive composition or the dry weight of the imageable layer prepared there from.

Other useful polymeric binders include, without limitation, polyvinylacetals, polyvinylbutyrals, polyesters, cellulosic polymers, epoxies, polystyrenes and copolymers such as syrene-acrylonitrile, and stryrene-maleic anhydride. (Meth)acrylic copolymers are particularly versatile materials due to the diverse number of monomers with which they may be copolymerized. Examples of monomers used to produce (meth)acrylic copolymers include, methyl(meth)acrylate, ethyl(meth)acrylate, (meth)acrylic acid, N-phenylmaleimide, styrene, polyethyleneglycolmethacrylate, (meth)acrylamide and (meth)acrylonitriles, allyl methacrylate, isocyanatoethymethacrylate, and the like. Other useful monomers may be prepared by reacting hydroxyethylmethacrylate with an isocyanate or sulfonylisocyanate, or reacting isocyanatoethymethacrylate with a sulfonamide.

Another particularly useful class of polymers is the polyurethane family and derivatives thereof. The majority of polyurethanes are synthesized by reacting at least a multifunctional isocyanate with a polyol. They may also include hybrids and copolymers, such as urethane-urea polymers, urethane-acrylic polymers and urethane-acrylic hybrid polymers.

### 2.2.4 Radiation Absorber

The photoresponsive compositions also include a radiation-absorbing compound (sometimes called a “sensitizer”) that is sensitive to radiation at a desired wavelength. These compounds absorb the radiation and facilitate polymerization during imaging. The radiation-absorbing compounds can be sensitive to radiation having a wavelength of from about 150 to about 1400 nm. The compounds sensitive to UV and visible radiation generally have a λₘₐₓ of from about 150 to about 600 nm, e.g., from about 200 to about 550 nm.

In some embodiments, the photoresponsive composition contains a UV sensitizer where the free-radical generating compound is UV radiation sensitive (that is, at least 250 nm and up to and including 450 nm), thereby facilitating photopolymerization. Typical UV photoresponsive free-radical generating compounds are described above. In some preferred embodiments, the radiation sensitive compositions are sensitized to “violet” radiation in the range of at least 375 nm and up to and including 450 nm. Useful sensitizers for such compositions include certain pyrilium and thiopyrilium dyes and 3-ketocoumarins (particularly in combination with a polycarboxylic acid free radical generating compound, such as anilino-N,N-diacetic acid).

Sensitizers that absorb in the visible region of the electromagnetic spectrum (that is, at least 400 nm and up to and including 650 nm) can also be used. Examples of such sensitizers are well known in the art and include the compounds described in cols. 17-22 of U.S. Pat. No. 6,569,603, the disclosure of which is incorporated herein by reference. Other useful visible and UV-sensitive sensitizing compositions include a cyanine dye, diaryliodonium salt, and a co-initiator (as described above) as disclosed in U.S. Pat. No. 5,368,990. Other useful sensitizers for the violet/visible region of sensitization are the 2,4,5-triaryloxazole derivatives as described in WO 2004/074930, which is incorporated herein by reference. These compounds can be used alone or with a co-initiator as described above, and especially with the 1,3,5-triazines described above or with thiol compounds. Useful 2,4,5-triaryloxazole derivatives can be represented by the Structure G-(Ar₁)₃ wherein Art is the same or different, substituted or unsubstituted carbocyclic aryl group having 6 to 12 carbon atoms in the ring, and G is a furan, oxazole, or oxadiazole ring. The Art groups can be substituted with one or more halo, substituted or unsubstituted alkyl, substituted or unsubstituted cycloalkyl, substituted or unsubstituted aryl, amino (primary, secondary, or tertiary), or substituted or unsubstituted alkoxy or aryloxy groups. Thus, the aryl groups can be substituted with one or more R′₁ through R′₃ groups, respectively, that are independently hydrogen or a substituted or unsubstituted alkyl group having from 1 to 20 carbon atoms (such as methyl, ethyl, iso-propyl, n-hexyl, benzyl, and methoxymethyl groups) substituted or unsubstituted carbocyclic aryl group having 6 to 10 carbon atoms in the ring (such as phenyl, naphthyl, 4-methoxyphenyl, and 3-methylphenyl groups), substituted or unsubstituted cycloalkyl group having 5 to 10 carbon atoms in the ring, a —N(R′₄)(R′₅) group, or a —OR′₆ group where R′₄ through R′₆ independently represent substituted or unsubstituted alkyl or aryl groups as defined above. At least one of R′₁ through R′₃ may be an —N(R′₄)(R′₅) group where R′₄ and R′₅ are the same or different alkyl groups. Substituents for each Art group include the same or different primary, secondary, and tertiary amines, e.g., the same dialkylamines.

Still another class of useful violet/visible radiation sensitizers includes compounds represented by the structure Ar₁-G-Ar₂ where Ar₁ and Ar₂ are the same or different substituted or unsubstituted aryl groups having 6 to 12 carbon atoms in the ring, or Ar₂ can be an arylene-G-Ar₁ or arylene-G-Ar₂ group, and G is a furan, ozazole, or oxadiazole ring. Ar₁ is the same as defined above, and Ar₂ can be the same or different aryl group as Ar₁. “Arylene” can be any of the aryl groups defined for Ar₁ but with a hydrogen atom removed to render them divalent in nature.

Additional useful “violet”-visible radiation sensitizers are described in WO 2004/074929. These compounds comprise the same or different aromatic heterocyclic groups connected with a spacer moiety that comprises at least one carbon-carbon double bond that is conjugated to the aromatic heterocyclic groups, and are represented in more detail by Formula (I) of the noted publication.

In some commercial applications, the radiation-absorbing compounds are sensitive to IR and near-IR radiation, that is, a wavelength of from about 600 to about 1400 nm, e.g., from about 700 to about 1200 nm. Such near-IR absorbers include carbon blacks and other IR-absorbing pigments and various IR-sensitive dyes (“IR dyes”), which are preferred. Examples of suitable IR dyes include but are not limited to, azo dyes, squarilium dyes, croconate dyes, triarylamine dyes, thiazolium dyes, indolium dyes, oxonol dyes, oxaxolium dyes, cyanine dyes, merocyanine dyes, phthalocyanine dyes, indocyanine dyes, indotricarbocyanine dyes, oxatricarbocyanine dyes, thiocyanine dyes, thiatricarbocyanine dyes, merocyanine dyes, cryptocyanine dyes, naphthalocyanine dyes, polyaniline dyes, polypyrrole dyes, polythiophene dyes, chalcogenopyryloarylidene and bi(chalcogenopyrylo)polymethine dyes, oxyindolizine dyes, pyrylium dyes, pyrazoline azo dyes, oxazine dyes, naphthoquinone dyes, anthraquinone dyes, quinoneimine dyes, methine dyes, arylmethine dyes, squarine dyes, oxazole dyes, croconine dyes, porphyrin dyes, and any substituted or ionic form of the preceding dye classes. Suitable dyes are also described in U.S. Pat. Nos. 5,208,135, 6,569,603, and 6,787,281, and EP Publication 1,182,033. A general description of one class of suitable cyanine dyes is shown by the formula in paragraph [0026] of WO 2004/101280. In addition to low-molecular-weight IR-absorbing dyes, IR dye moieties bonded to polymers can be used as well. Moreover, IR dye cations can be used as well, that is, the cation is the IR-absorbing portion of the dye salt that ionically interacts with a polymer comprising carboxy, sulfo, phospho, or phosphono groups in the side chains.

Near-IR-absorbing cyanine dyes are also useful and are described, for example, in U.S. Pat. Nos. 6,309,792, 6,264,920, 6,153,356, and 5,496,903. Suitable dyes may be formed using conventional methods and starting materials or obtained from various commercial sources including American Dye Source (Baie D'Urfe, Quebec, Canada) and FEW Chemicals (Germany). Other useful dyes for near infrared diode laser beams are described, for example, in U.S. Pat. No. 4,973,572.

Useful IR-absorbing compounds include carbon blacks, e.g., carbon blacks that are surface-functionalized with solubilizing groups are well known in the art. Carbon blacks that are grafted to hydrophilic, nonionic polymers, such as FX-GE-003 (manufactured by Nippon Shokubai), or which are surface-functionalized with anionic groups, such as CAB-O-JET 200 or CAB-O-JET® 300 (manufactured by the Cabot Corporation) are also useful.

The radiation absorber is present in sufficient amounts to sensitize the coating to laser radiation produced by a laser. For example, the radiation-absorbing compound can be present in the photoresponsive composition in an amount generally of from about 1% to about 20% and preferably from about 1.5 to about 10%, based on total solids in the composition that also corresponds to the total dry weight of the imageable layer. Alternatively, the amount can be defined by an absorbance in the range of from about 0.05 to about 3, and preferably of from about 0.1 to about 1.5, in the dry film as measured by reflectance UV-visible spectrophotometry. The particular amount needed for this purpose would be readily apparent to one skilled in the art, depending upon the specific compound used.

### 2.3 Optional Topcoat 115

The topcoat 115, if present, provides an oxygen barrier and prevents handling (e.g., fingerprint) damage to the photoresponsive layer 110. Typically, the topcoat is a water-soluble polymer or polymers cast on top of the photoresponsive layer 110. Examples of materials most useful for their oxygen barrier properties are polyvinyl alcohols, including fully or partially hydrolysed polymers and mixtures thereof. Examples of such materials are SELVOL polyvinyl alcohols from Sekisui Chemical and MOWIOL polyvinylalcohols from Kuraray America Inc. Such an oxygen-barrier layer may be cast and dried to produce the finished lithographic printing plate. Typically the dried topcoat film has a dry coat weight of no more than about 300 mg/ft².

The imageable elements have any useful form including but not limited to, printing plate precursors, printing cylinders, printing sleeves and printing tapes (including flexible printing webs). The imageable members are printing plate precursors that can be of any useful size and shape (for example, square or rectangular) having the requisite imageable layer disposed on a suitable substrate. Printing cylinders and sleeves are known as rotary printing members having the substrate and imageable layer in a cylindrical form. Hollow or solid metal cores can be used as substrates for printing sleeves.

### EXAMPLES

Terms used in the examples that follow include the following:

S0507: An-IR absorbing dye, available from FEW chemicals GmbH, Bitterfeld-Wolfen, Germany:

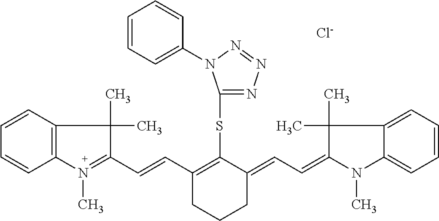

IRT: An IR-absorbing dye, available from Showa Denko, Tokyo, Japan.

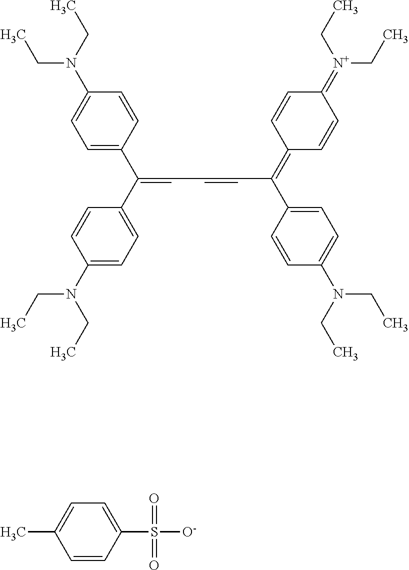

CYCLOMER Z250: A 45% solution of acrylic resin in dipropylene glycol methyl ether, supplied by Allnex USA Inc, Smyrna, Ga.

29S1763: A pigment dispersion comprising phthalocyanine blue 15-4, (14.4 parts), Cyclomer Z250, (20.9 parts), BYK342 (2 parts), 1-methoxy-2-propanol, (62.7 parts), prepared by Penn Color, Doylestown, Pa.

NEOREZ 1391: An aliphatic polyurethane polymer manufactured by DSM resins and available from TMC materials, Shrewsbury Mass.

UCECOAT 7710: A radiation-curable polyurethane dispersion available from Allnex. Alpharetta, Ga.

BYK 342: A silicone surface additive, supplied by BYK USA Inc, Wallingford, Conn.

SR399: Dipentaerythritol Penta acrylate, available from Sartomer, Exton, Pa.

CN9167US: An aromatic urethane oligomer, available from Sartomer, Exton, Pa.

SIPOMER PAM-100: Phosphate esters of polyethylene glycol monomethacrylate, available from Nexeo Solutions, Dublin, Ohio.

CFB63: A color forming dye available from DKSH North America Inc., Mt. Arlington, N.J.

Sodium tetraphenylborate: Available from Sigma Aldrich St Louis, Mo.

OMNICAT 250: 4-methylphenyl-[4-(2-methylpropyl)phenyl] iodonium hexafluorophosphate 75% in propylene carbonate, available from IGN resins, Charlotte, N.C.

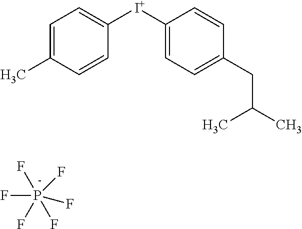

PAG 513: 4-methylphenyl-[4-(2-methylpropyl)phenyl] iodonium tetraphenylborate, available from Charkit Chemical Corporation, Norwalk, Conn.

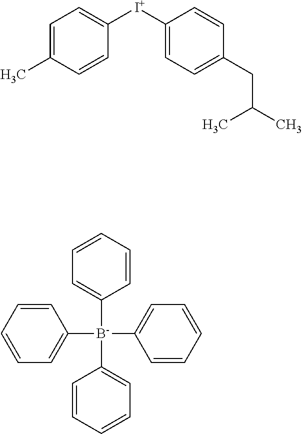 [SMILES: Cc1ccc([I+]c2ccc(CC(C)C)cc2)cc1 ; c1ccc([B-](c2ccccc2)(c2ccccc2)c2ccccc2)cc1]

Iodonium A: S2525, phenyl-(4-butoxyphenyl) iodonium hexafluorophosphate available from FEW chemicals GmbH, Bitterfeld-Wolfen, Germany.

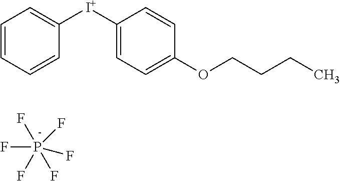

Iodonium B: Bis(4-methylphenyl)iodonium hexafluorophosphate, available from Sigma Aldrich St Louis, Mo.

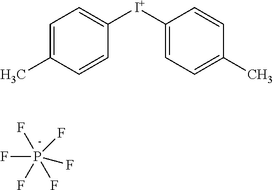

Iodonium C: Diphenyliodonium chloride, available from Sigma Aldrich St Louis, Mo.

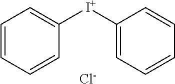 [SMILES: c1ccc([I+]c2ccccc2)cc1 ; [Cl-]]

Iodonium D: 3-methylphenyl-(2,4,6-trimethylphenyl) iodonium triflate, available from Sigma Aldrich St Louis, Mo.

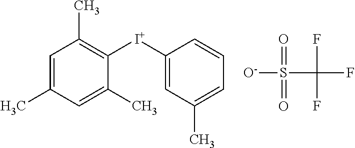 [SMILES: Cc1cccc([I+]c2c(C)cc(C)cc2C)c1 ; O=S(=O)([O-])C(F)(F)F]

Iodonium E: Bis(4-methoxyphenyl)iodonium bromide, available from Sigma Aldrich St Louis, Mo.

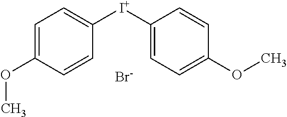 [SMILES: COc1ccc([I+]c2ccc(OC)cc2)cc1 ; [Br-]]

SELVOL 21-205: A 21% polyvinylalcohol solution in water, supplied by Brenntag Northeast, Reading, Pa.

CAPSTONE FS-30: A 25% solution by weight of an ethoxylated nonionic fluorosurfactant in water, supplied by DuPont, Wilmington, Del.

TITAN dense black ink: Available from Spinks Ink Co. Addison, Ill.

Substrate A: 0.012″×16″×22″ aluminum sheet that has been brush grained, electro-grained, anodized and post-treated with sodium metasilicate.

Washout solution: A subtractive lithographic developer, supplied, e.g., by Presstek LLC, Hudson, N.H.

VN-1: A gum arabic based plate finisher, supplied by Presstek LLC, Hudson, N.H.

NES OPAL 850: A cleanout unit used to process and gum plates in a single step, as supplied by NES Worldwide Inc, Westfield, Mass.

### Synthesis of Iodonium Borate Salts

Iodonium borate IB-A: 6.25 g Iodonium A was dissolved in 120 g n-propanol and diluted further with 120 g distilled water. 4.38 g sodium tetraphenyl borate was dissolved in 40 g n-propanol and diluted further with 80 g distilled water. The sodium tetraphenylborate solution was slowly added to the Iodonium A solution and stirred for 1 hour. The resulting precipitate, Iodonium IB-A was filtered, washed in an excess of distilled water, filtered again and dried for 2 days at 450° C.

Iodonium borate IB-B: 0.57 g Iodonium B was dissolved in 12 g n-propanol and diluted further with 12 g distilled water. 0.438 g sodium tetraphenylborate was dissolved in 10 g n-propanol and diluted further with 20 g distilled water. The sodium tetraphenylborate solution was slowly added to the Iodonium B solution and stirred for 1 hour. The resulting precipitate, iodonium borate IB-B was filtered, washed in an excess of distilled water, filtered again and dried for 2 days at 450° C.

Iodonium borate IB-C: 0.48 g Iodonium C was dissolved in 12 g n-propanol and diluted further with 12 g distilled water. 0.53 g sodium tetraphenyl borate was dissolved in 10 g n-propanol and diluted further with 20 g distilled water. The sodium tetraphenylborate solution was slowly added to the Iodonium C solution and stirred for 1 hour. The resulting precipitate, Iodonium IB-C was filtered, washed in an excess of distilled water, filtered again and dried for 2 days at 450° C.

Iodonium borate IB-D: 0.293 g Iodonium D was dissolved in 12 g n-propanol and diluted further with 12 g distilled water. 0.211 g sodium tetraphenyl borate was dissolved in 10 g n-propanol and diluted further with 20 g distilled water. The sodium tetraphenylborate solution was slowly added to the Iodonium D solution and stirred for 1 hour. The resulting precipitate, Iodonium IB-D was filtered, washed in an excess of distilled water, filtered again and dried for 2 days at 450° C.

Iodonium borate IB-E: 0.276 g Iodonium E was dissolved in 12 g n-propanol and diluted further with 12 g distilled water. 0.228 g sodium tetraphenyl borate was dissolved in 10 g n-propanol and diluted further with 20 g distilled water. The sodium tetraphenylborate solution was slowly added to the Iodonium E solution and stirred for 1 hour. The resulting precipitate, Iodonium IB-E was filtered, washed in an excess of distilled water, filtered again and dried for 2 days at 450° C.

### Examples

The following examples demonstrate the crystallization behavior of various iodonium borate salts when formulated into negative-working, develop-on-press lithographic printing plate precursors:

Coating Formulation

Basecoat stock solutions: stock solution components were mixed for a minimum of 12 hours before use.

| | Stock solution A | Stock solution B |
|---|---|---|
| | amount by | amount by |
| Components | weight in 100 g | weight In 100 g |
| Dowanol PM | 90.040 g | 80.080 g |
| Dimethyformamide | 4.015 g | 8.029 g |
| CFB63 | 0.158 g | 0.316 g |
| Sodium tetraphenyl borate | 0.226 g | 0.452 g |
| S0507 | 0.068 g | 0.135 g |
| Byk 342 | 0.025 g | 0.050 g |
| SR399 | 2.663 g | 5.325 g |
| Neorez 1391 (33% in water) | 2.053 g | 4.106 g |
| Ucecoat 7710 (45% in water) | 0.753 g | 1.505 g |

Basecoat coating formulations: the iodonium salts were added to the stock solutions and mixed for a minimum of 12 hours before use.

| | | stock solu- | |
|---|---|---|---|
| Formulation | iodonium salt | tion A | stock solu- |
| Examples | (grams) | (grams) | tion B |
| Example1 | Iodonium A | 0.072 g | 19.928 g |
| Example2 | Iodonium borate IB-A | 0.096 g | 19.904 g |
| ExampleC3 | Omnicat 250 | 0.072 g | 19.928 g |
| ExampleC4 | PAG 513 | 0.072 g | 19.928 g |
| ExampleC5 | Iodonium B | 0.072 g | 19.928 g |
| ExampleC6 | Iodonium borate IB-B | 0.072 g | 19.928 g |
| ExampleC7 | Iodonium C | 0.072 g | 19.928 g |
| ExampleC8 | Iodonium borate IB-C | 0.072 g | 19.928 g |
| ExampleC9 | Iodonium D | 0.072 g | 19.928 g |
| ExampleC10 | Iodonium borate IB-D | 0.072 g | 19.928 g |

For formulas 11 and 12, 0.072 g of iodonium salt were pre-dissolved in 9.928 g methanol.

| | | | |
|---|---|---|---|
| Example11 | Iodonium E solution | 10.0 g | 9.904 g |
| Example12 | Iodonium borate IB-E solution | 10.0 g | 9.904 g |

Topcoat solution:

| Component | % by weight |
|---|---|
| water | 89.54 |
| Selvol 21-205 (21% in water) | 10.37 |
| Capstone FS-30 (25% in water) | 0.09 |

Experimental Procedure

The photosensitive basecoat examples were applied to Substrate A with a 0.012″ wire-wound bar. The resulting plates were dried in an oven at 800° C. for 90 seconds to provide a dry coat weight of about 0.98 g/m². Topcoat solution was applied each photosensitive coating with a 0.08″ wire-wound bar and dried for 90 seconds at 800° C. to provide a dry coat weight of about 0.36 g/m².

The resulting negative-working, IR sensitive printing plates were subject to the following tests:

Test 1. On-Press Development

The printing plates were exposed on a PRESSTEK DIMENSION PRO 800 plate-setter set up to write a suitable test pattern at an exposure energy of about 160 mJ/cm². Each exposed plate was mounted directly onto a HEIDELBERG GTO printing press equipped with Titan dense black ink and a fountain solution of ANCHOR EMERALD JRB2077, 3 oz/gallon and ANCHOR AR5-SV, 2 oz/gallon. The plate cylinder was rotated for 5 seconds while wetting the plate with only fountain solution before engaging the ink and impression cylinder. 200 sheets were printed and the number of impressions required to produce a clean printed sheet was recorded.

Test 2. Susceptibility to Crystallization.

Plates coated with each formulation example were tested after being subject to the following environmental conditions:

1. Fresh plate. Not subject to adverse storage conditions.

2. Dry aged plate, wrapped in paper and stored in a dry oven at 480° C. for 5 days.

3. Humid aged plate, hung in an environmental chamber at 400° C. and 80% relative humidity for 5 days.

Plates were imaged SCREEN PLATE RITE PTR8600 plate-setter using an internal test pattern at an exposure of about 160 mJ/cm². The test pattern contained solid areas as well as 1×1 and 2×2 pixel lines. The exposed areas were rubbed 60 times with a cloth soaked in benzyl alcohol, then rinsed and dried. The areas rubbed with benzyl alcohol were treated with Presstek VN-1 gum and dried. A damp cloth was then used to apply black rubbing ink to the exposed areas. The inked image areas were inspected at 12× magnification for the presence of voids caused by crystal formation and rated on a scale of 1 to 5.

1. No crystals.

2. Trace 1-5 crystals per square inch.

3. Moderate 6-25 crystals per square inch.

4. Heavy 25-100 crystals per square inch.

5. Severe>100 crystals per square inch.

Results

| | | test 2 crystal formation under | | |
|---|---|---|---|---|
| | test 1 | different storage conditions | | |
| | #press | fresh plate | | humid aged |
| formulation | sheets | ambient | dry aged | 5 days 40° C., |
| example | to clean | conditions | 5 days, 48° C. | 80% humid |
| Example 1 | 10 | 1 | 1 | 1 |
| Example 2 | 25 | 1 | 1 | 1 |
| Example C3 | 15 | 1 | 4 | 4 |
| Example C4 | 25 | 2 | 5 | 5 |
| Example C5 | 50 | 1 | 2 | 2 |
| Example C6 | 20 | 1 | 1 | 3 |
| Example C7 | 25 | 1 | 3 | 4 |
| Example C8 | 200 | 1 | 3 | 3 |
| Example C9 | 15 | 1 | 3 | 3 |
| Example C10 | 100 | 1 | 1 | 3 |
| Example 11 | 20 | 1 | 1 | 1 |
| Example 12 | 20 | 1 | 1 | 1 |

Formulation examples 1, 2, 11 and 12 contain iodonium salts with short-chain alkoxy substituents. They do not suffer from crystal formation.

Comparative examples C3 to C10 contain iodonium salts with short-chain alkyl substituents. They all suffer from crystal formation to some degree, which would result in unacceptable print quality.

The following examples demonstrate the crystallization behavior of various iodonium borate salts when formulated into conventionally processed negative-working lithographic printing plate precursors:

Coating Formulation

Basecoat stock solutions: stock solution components were mixed for a minimum of 12 hours before use.

| | Stock solution C |
|---|---|
| Components | amount by weight in 100 g |
| Dowanol PM | 54.134 |
| Methylethylketone | 35.704 |
| Dimethyformamide | 5.101 |
| IRT | 0.073 |
| 2917S63 | 2.310 |
| SR399 | 1.443 |
| CN9167US | 0.858 |
| BYK342 | 0.009 |
| PAM100 | 0.367 |

Basecoat coating formulations: the iodonium salts and sodium tetraphenylborate were added to the stock solutions and mixed for a minimum of 12 hours before use.

| | | | sodium | stock |
|---|---|---|---|---|
| Formulation | iodonium salt | | tetraphenylborate | solution A |
| Examples | (grams) | | (grams) | (grams) |
| Example13 | Iodonium A | 0.180 g | 0.203 g | 99.618 g |
| Example14 | Iodonium borate | 0.383 g | | 99.555 g |
| | IB-A | | | |
| ExampleC15 | Omnicat 250 | 0.180 g | 0.203 g | 99.618 g |
| ExampleC16 | PAG513 | 0.383 g | | 99.618 g |

Topcoat solution:

| Component | % by weight |
|---|---|
| water | 89.54 |
| Selvol 21-205 (21% in water) | 10.37 |
| Capstone FS-30 (25% in water) | 0.09 |

Experimental Procedure

The photosensitive basecoat examples were applied to Substrate A with a 0.012″ wire-wound bar. The resulting plates were dried in an oven at 800 C for 120 seconds to provide a dry coat weight of about 0.98 g/m². Topcoat solution was applied each photosensitive coating with a 0.08″ wire-wound bar and dried for 1200 seconds at 800° C. to provide a dry coat weight of about 0.36 g/m².

The resulting negative-working, IR sensitive printing plate precursors were subject to the following crystallization test:

Plates coated with each formulation example were tested after being subject to the following environmental conditions:

1. Fresh plate. Not subject to adverse storage conditions.

2. Dry aged plate, wrapped in paper and stored in a dry oven at 480 C for 5 days.

3. Humid aged plate, hung in an environmental chamber at 400 C and 80% relative humidity for 5 days.

4. Plates were imaged SCREEN PLATE RITE PTR8600 plate-setter using an internal test pattern at an exposure of about 160 mJ/cm². The test pattern contained solid areas as well as 1×1 and 2×2 pixel lines. After exposure, the plates were processed at a transport speed of 4 feet/min through an NES850 processor equipped with PRESSTEK washout solution. After processing, the solids and pixel lines were inspected for the presence of voids caused by crystal formation and rated on a scale of 1 to 5.

1. No crystals.

2. Trace 1-5 crystals per square inch.

3. Moderate 6-25 crystals per square inch.

4. Heavy 25-100 crystals per square inch.

5. Severe>100 crystals per square inch.

Results

| | crystal formation under different storage conditions | | |
|---|---|---|---|
| | fresh plate | | humid aged |
| Formulation | ambient | dry aged | 5 days 40° C., |
| example | conditions | 5 days, 48° C. | 80% humid |
| Example 13 | 1 | 1 | 1 |
| Example 14 | 1 | 1 | 1 |
| Example C15 | 1 | 3 | 3 |
| Example C16 | 2 | 5 | 5 |

Formulation examples 13 and 14 contain iodonium salts with short-chain alkoxy substituents. They do not suffer from crystal formation.

Comparative examples C15 to C16 contain iodonium salts with short-chain alkyl substituents. They suffer from crystal formation which would result in unacceptable print quality.

Although the present invention has been described with reference to specific details, it is not intended that such details should be regarded as limitations upon the scope of the invention, except as and to the extent that they are included in the accompanying claims.

What is claimed is:

1. A lithographic printing member comprising:
a hydrophilic first layer; and
thereover, an oleophilic imaging layer comprising (i) a component polymerizable by a free-radical polymerization mechanism, (ii) an initiator for generating, upon exposure to imaging radiation, free radicals to initiate polymerization of the polymerizable component, (iii) a radiation absorber, and (iv) a polymeric binder,
wherein the initiator is an iodonium borate compound having the structure 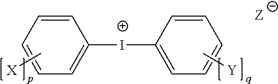
where X and Y are alkoxy, p and q range independently from 0 to 5, p+q≤5, and Z^{⊕} is an organic anion.

2. The printing member of claim 1, wherein p and q range independently from 0 to 4, and p+q≤4.

3. The printing member of claim 1, wherein the iodonium borate compound is phenyl-(4-butoxyphenyl)-iodonium tetraphenylborate.

4. The printing member of claim 1, wherein the iodonium borate compound is bis(4-methoxyphenyl)iodonium tetraphenylborate.

5. The printing member of claim 1, wherein Z^{⊕} has the structure 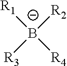
where R₁, R₂, R₃, and R₄ are independently alkyl, aryl, alkenyl, alkynyl, cycloalkyl, or heterocyclyl groups, or two or more of R₁, R₂, R₃, and R₄ can be joined together to form a heterocyclic ring with the boron atom.

6. The printing member of claim 1, further comprising a topcoat over the imaging layer.

7. The printing member of claim 6, wherein the topcoat is a polyvinylalcohol.

8. The printing member of claim 1, wherein the polymeric binder is a polyurethane.

9. A method of preparing and printing with a lithographic printing member, the method comprising the steps of:
providing a lithographic printing member comprising:
(a) a hydrophilic first layer; and
(b) thereover, an oleophilic imaging layer comprising (i) a component polymerizable by a free-radical polymerization mechanism, (ii) an initiator for generating, upon exposure to imaging radiation, free radicals to initiate polymerization of the polymerizable component, (iii) a radiation absorber, and (iv) a polymeric binder, wherein the initiator is an iodonium borate compound having the structure 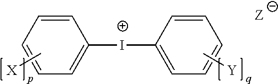
where X and Y are alkoxy, p and q range independently from 0 to 5, p+q≤5, and Z^{⊕} is an organic anion, the printing member not exhibiting blooming;
exposing the printing member to imaging radiation in an imagewise pattern to cause polymerization of the polymerizable component;
developing the printing member to remove only unexposed portions of the imaging layer;
mounting the printing member on a printing press; and
printing with the printing member to transfer ink in the imagewise pattern onto recording media.

10. The method of claim 9, wherein the developing step occurs prior to the mounting step.

11. The method of claim 9, wherein the developing step occurs following the mounting step.

12. The method of claim 9, wherein p and q range independently from 0 to 4, and p+q≤4.

13. The method of claim 9, wherein the iodonium borate compound is phenyl-(4-butoxyphenyl)-iodonium tetraphenylborate.

14. The method of claim 9, wherein the iodonium borate compound is bis(4-methoxyphenyl)iodonium tetraphenylborate.

15. The method of claim 9, wherein Z^{⊕} has the structure 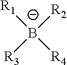
where R₁, R₂, R₃, and R₄ are independently alkyl, aryl, alkenyl, alkynyl, cycloalkyl, or heterocyclyl groups, or two or more of R₁, R₂, R₃, and R₄ can be joined together to form a heterocyclic ring with the boron atom.

16. The method of claim 9, wherein the printing member further comprises a topcoat over the imaging layer.

17. The method of claim 16, wherein the topcoat is a polyvinylalcohol.

18. The method of claim 9, wherein the polymeric binder is a polyurethane.
